(19) United States
(12) Patent Application Publication
(10) Pub. No.: US 2017/0184250 A1
(43) Pub. Date: Jun. 29, 2017

(54) MOUNTING BRACKET METHOD AND SYSTEM

(71) Applicant: Dony Dawson, Keller, TX (US)

(72) Inventor: Dony Dawson, Keller, TX (US)

(21) Appl. No.: 14/981,973

(22) Filed: Dec. 29, 2015

(51) Int. Cl. F16M 13/02

(52) U.S. Cl. CPC F16M 13/02

(57) ABSTRACT

Disclosed are a method and/or a system of a mounting bracket. In one aspect, the mounting bracket includes a rectilinear faceplate. The rectilinear faceplate has three edges. The adjacent edges produce a specific angle between the adjacent edges. The rectilinear faceplate is capable of being attached to an item to be mounted onto a surface. The mounting bracket includes three walls where each edge is adjoined perpendicular to a corresponding wall. The mounting bracket includes three lips. Each lip is adjoined perpendicular to the corresponding wall such that each edge is associated with a corresponding lip. Each lip is capable of attaching to a fixture affixed to the surface. The mounting bracket allows the item to be mounted on the surface in two specific orientations. The two specific orientations are determined based on being able to rotate the item by a difference between 180 degrees and the specific angle.

### FIELD OF THE TECHNOLOGY

This invention relates generally to a mounting bracket, and more particularly to a multidirectional mounting bracket.

### BACKGROUND

A mounting bracket may be a structural element attached to an item and used to support that item when it is mounted on a wall. The mounting bracket may include a single lip which couples to a fixture attached to the wall. Once the mounting bracket is attached to the item, the orientation in which the item may be mounted may be permanent, either vertical or horizontal, as a direct result of the mounting bracket having a single lip. Therefore, reorienting the item may require removing and reattaching the mounting clip and/or attaching an additional mounting bracket in order to support the new orientation. Moreover, a mounting bracket with a single lip may be prone to error in installation requiring the item to be reoriented. Therefore using a mounting bracket with a single lip may be burdensome, time intensive, and/or costly when an item needs to be reoriented on the wall to which it is mounted.

### SUMMARY

Disclosed are a method and/or a system of a mounting bracket.

In one aspect, the mounting bracket includes a rectilinear faceplate. The rectilinear faceplate has three edges. The adjacent edges produce a specific angle between the adjacent edges. The rectilinear faceplate is capable of being attached to an item to be mounted onto a surface. The mounting bracket further includes three walls where each edge is adjoined perpendicular to a corresponding wall. In addition, the mounting bracket includes three lips. Each lip is adjoined perpendicular to the corresponding wall such that each edge is associated with a corresponding lip.

Each lip is capable of attaching to a fixture affixed to the surface. The mounting bracket allows the item to be mounted on the surface in two specific orientations. The two specific orientations are determined based on being able to rotate the item by a difference between 180 degrees and the specific angle.

The fixture may be a Z clip and/or a French cleat. The rectilinear faceplate may be a square and/or a rectangle. The specific angle may be 90 degrees. The mounting bracket may allow the item to be mounted on the surface in four specific orientations. The four specific orientations may be determined based on being able to rotate the item by 90 degrees, 180 degrees, 270 degrees, and/or 360 degrees. Each lip may have a chamfer. The chamfer may be configured to enable each lip to self-actuate a connection to the fixture and/or tighten the connection as each lip is attached to the fixture.

The rectilinear faceplate may include a front portion and/or a back portion. The back portion may be capable of being attached to an item to be mounted onto the surface. The back portion may include an uneven texture to enable a higher adhesion point for attaching the back portion to the item. The mounting bracket may include a metal alloy. The item to be mounted may be a glass writing surface.

In another embodiment, a mounting bracket includes a circular faceplate. The circular faceplate has one continuous edge. The circular faceplate is capable of being attached to an item to be mounted onto a surface. Further, the mounting bracket includes a continuous wall. The continuous wall is adjoined perpendicular to the continuous edge such that the continuous wall is positioned around an entire perimeter of the circular faceplate. In addition, the mounting bracket includes a continuous lip. The continuous lip is adjoined perpendicular to the continuous wall such that the continuous lip is positioned around the entire perimeter of the circular faceplate.

The continuous lip is capable of attaching to a fixture affixed to the surface. The mounting bracket allows the item to be mounted on the surface in any orientation. The continuous lip may have a chamfer. The circular faceplate may include a front portion and/or a back portion.

In yet another embodiment, a method of mounting an item onto a surface includes attaching a mounting bracket having a rectilinear faceplate, three walls, and three lips to the item using the rectilinear faceplate. The rectilinear faceplate has three edges. The adjacent edges produce a specific angle between the adjacent edges. Each edge is adjoined perpendicular to a corresponding wall. Each lip is adjoined perpendicular to the corresponding wall such that each edge is associated with a corresponding lip.

A lip is attached to a fixture affixed to the surface. The mounting bracket allows the item to be mounted on the surface in two specific orientations. The two specific orientations are determined based on being able to rotate the item by a difference between 180 degrees and the specific angle.

The methods and/or systems disclosed herein may be implemented in any means for achieving various aspects. Other features will be apparent from the accompanying drawings and from the detailed description that follows.

### BRIEF DESCRIPTION OF THE FIGURES

Example embodiments are illustrated by way of example and not limitation in the figures of the accompanying drawings, in which like references indicate similar elements and in which:

FIG. 1 is a rectilinear mounting bracket view, according to one embodiment.

FIG. 2A is a front view of a mounting bracket of FIG. 1, according to one embodiment.

FIG. 2B is back view of the mounting bracket of FIG. 1, according to one embodiment.

FIG. 3 is a side view of mounted item, according to one embodiment.

FIG. 4A is a specific orientations front views, according to one embodiment.

FIG. 4B is a specific orientations back views, according to one embodiment.

FIG. 5 is a circular mounting bracket view, according to one embodiment.

FIG. 6 is a block diagram illustrating attachment of a rectilinear faceplate, walls, and lips to an item, according to one embodiment.

FIG. 7 is a process flow of attaching a lip to a fixture, according to one embodiment.

Other features of the present embodiments will be apparent from the accompanying drawings and from the detailed description that follows.

### DETAILED DESCRIPTION

Disclosed are a method and/or a system of a mounting bracket 100. In one embodiment, the mounting bracket 100 includes a rectilinear faceplate 102. The rectilinear faceplate 102 has three edges (e.g., edge 104). The adjacent edges 106 produce a specific angle 108 between the adjacent edges 106. The rectilinear faceplate 102 is capable of being attached to an item 300 to be mounted onto a surface 302, according to one embodiment.

The mounting bracket 100 further includes three walls (e.g., wall 110) where each edge (e.g., edge 104) is adjoined perpendicular to a corresponding wall (e.g., wall 110). In addition, the mounting bracket 100 includes three lips (e.g., lip 112). Each lip (e.g., lip 112) is adjoined perpendicular to the corresponding wall (e.g., wall 110) such that each edge (e.g., edge 104) is associated with a corresponding lip (e.g., lip 112), according to one embodiment.

Each lip (e.g., lip 112) is capable of attaching to a fixture 304 affixed to the surface 302. The mounting bracket 100 allows the item 300 to be mounted on the surface 302 in two specific orientations. The two specific orientations are determined based on being able to rotate the item 300 by a difference between 180 degrees and the specific angle 108, according to one embodiment.

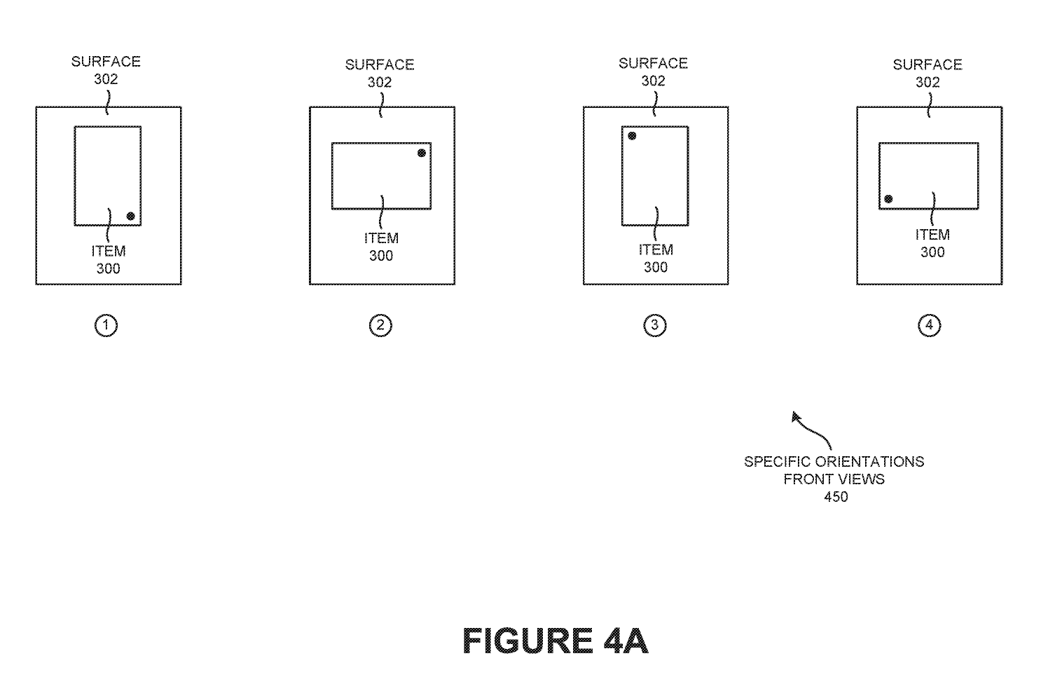

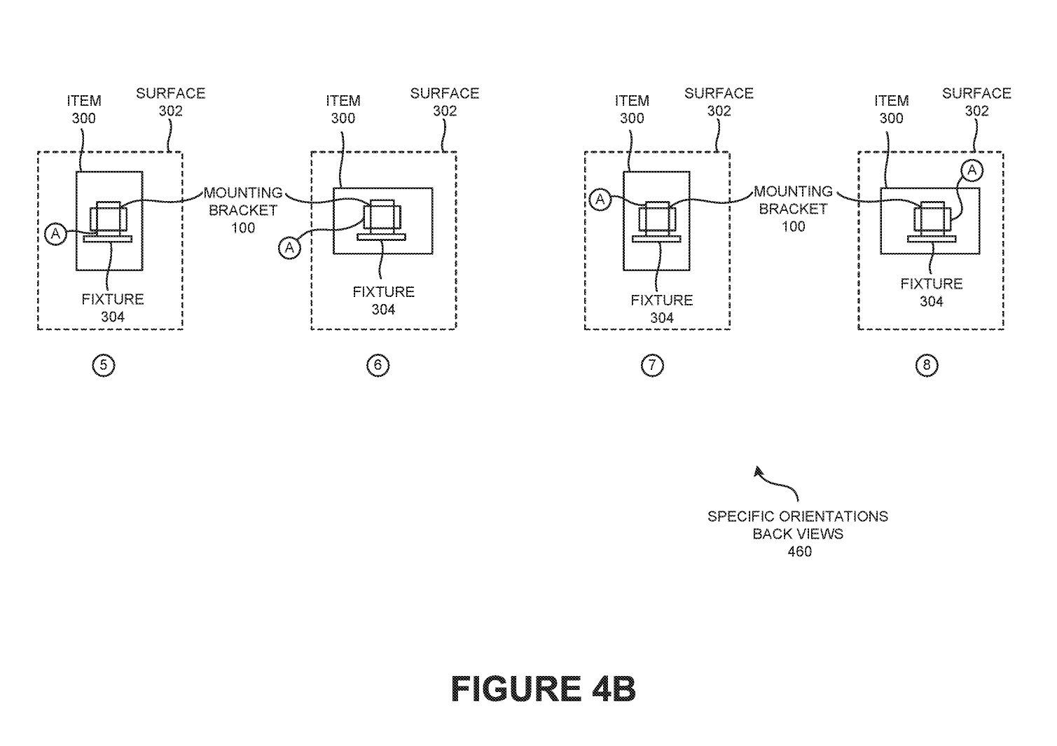

The fixture 304 may be a Z clip and/or a French cleat. The rectilinear faceplate 102 may be a square and/or a rectangle. The specific angle 108 may be 90 degrees. The mounting bracket 100 may allow the item 300 to be mounted on the surface 302 in four specific orientations (as shown in FIG. 4A and/or FIG. 4B). The four specific orientations may be determined based on being able to rotate the item 300 by 90 degrees, 180 degrees, 270 degrees, and/or 360 degrees. Each lip (e.g., lip 112) may have a chamfer 114. The chamfer 114 may be configured to enable each lip (e.g., lip 112) to self-actuate a connection 306 to the fixture 304 and/or tighten the connection 306 as each lip (e.g., lip 112) is attached to the fixture 304, according to one embodiment.

The rectilinear faceplate 102 may include a front portion 200 and/or a back portion 202. The back portion 202 may be capable of being attached to an item 300 to be mounted onto the surface 302. The back portion 202 may include an uneven texture (e.g., texture 204) to enable a higher adhesion point for attaching the back portion 202 to the item 300. The mounting bracket 100 may include a metal alloy. The item 300 to be mounted may be a glass writing surface, according to one embodiment.

In another embodiment, a mounting bracket 100 includes a circular faceplate 502. The circular faceplate 502 has a continuous edge 504. The circular faceplate 502 is capable of being attached to an item 300 to be mounted onto a surface 302. Further, the mounting bracket 500 includes a continuous wall 506. The continuous wall 506 is adjoined perpendicular to the continuous edge 504 such that the continuous wall 506 is positioned around an entire perimeter of the circular faceplate 502. In addition, the mounting bracket 100 includes a continuous lip 508. The continuous lip 508 is adjoined perpendicular to the continuous wall 506 such that the continuous lip 508 is positioned around the entire perimeter of the circular faceplate 502, according to one embodiment.

The continuous lip 508 is capable of attaching to a fixture 304 affixed to the surface 302. The mounting bracket 100 allows the item 300 to be mounted on the surface 302 in any orientation. The continuous lip 508 may have a chamfer 114. The circular faceplate 502 may include a front portion 200 and/or a back portion 202, according to one embodiment.

In yet another embodiment, a method of mounting an item 300 onto a surface 302 includes attaching a mounting bracket 100 having a rectilinear faceplate 102, three walls (e.g., wall 110), and three lips (e.g., lip 112) to the item 300 using the rectilinear faceplate 102. The rectilinear faceplate 102 has three edges (e.g., edge 104). The adjacent edges 106 produce a specific angle 108 between the adjacent edges 106. Each edge (e.g., edge 104) is adjoined perpendicular to a corresponding wall (e.g., wall 110). Each lip (e.g., lip 112) is adjoined perpendicular to the corresponding wall (e.g., wall 110) such that each edge (e.g., edge 104) is associated with a corresponding lip (e.g., lip 112), according to one embodiment.

A lip (e.g., lip 112) is attached to a fixture 304 affixed to the surface 302. The mounting bracket 100 allows the item 300 to be mounted on the surface 302 in two specific orientations. The two specific orientations are determined based on being able to rotate the item 300 by a difference between 180 degrees and the specific angle 108, according to one embodiment.

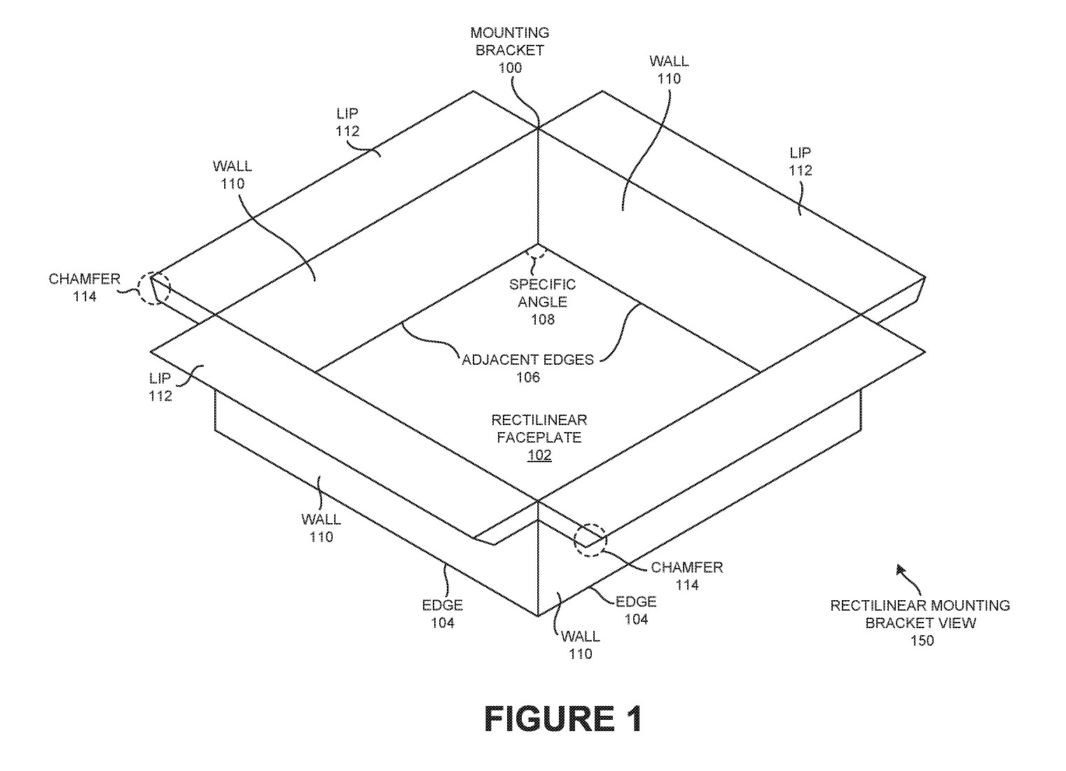

FIG. 1 is a rectilinear mounting bracket view 150, according to one embodiment. Particularly, the rectilinear mounting bracket view 150 includes a mounting bracket 100, a rectilinear faceplate 102, an edge 104, adjacent edges 106, a specific angle 108, a wall 110, a lip 112, and a chamfer 114, according to one embodiment.

The mounting bracket 100 may be a fixed point and/or a weight-bearing structural unit for attaching an item 300. In another embodiment, the mounting bracket 100 may be a rigid structure fixed to a vertical surface (e.g., surface 302) to support heavy bodies (e.g., item 300). The mounting bracket 100 may enable easy and/or secure mounting of the item 300. The mounting bracket 100 may allow the item 300 to be mounted on the surface 302 in four specific orientations. The mounting bracket 100 may consist of a metal alloy, according to one embodiment.

The rectilinear faceplate 102 may be a rigid flat surface having front portion 200 and/or a back portion 202. The rectilinear faceplate 102 may have three edges (e.g., edge 104). The rectilinear faceplate 102 is capable of being attached to an item 300 to be mounted onto a surface 302. In another embodiment, the rectilinear faceplate 102 may be a square and/or a rectangle. The edge(s) 104 may be a side or an outside limit of the rectilinear faceplate 102. Each edge 104 is adjoined perpendicular to a corresponding wall (e.g., wall 110), according to one embodiment.

The adjacent edge(s) 106 may be an adjoining edge(s) (e.g., edge 104). The specific angle 108 may be formed between the adjacent edge(s) 106. The specific angle 108 may be 90 degrees, according to one embodiment. The wall(s) 110 may be the adjoined side(s) along the perimeter of the rectilinear faceplate 102, according to one embodiment.

The lip 112 may be a part of edge 104 of the mounting bracket 100. Each lip (e.g., lip 112) is adjoined perpendicular to the corresponding wall (e.g., wall 110) such that each edge (e.g., edge 104) is associated with the corresponding lip (e.g., lip 112). Each lip (e.g., 112) is capable of attaching to a fixture 304 affixed to the surface 302. The lip(s) 112 may be on the entire perimeter of the rectilinear faceplate 102. Each lip 112 may have a chamfer 114, according to one embodiment.

The chamfer 114 may be a transitional edge of the lip(s) 112. The chamfer 114 may be configured to enable each lip 112 to self-actuate a connection 306 to the fixture 304 and/or tighten the connection 306 as each lip 112 is attached to the fixture 304, according to one embodiment.

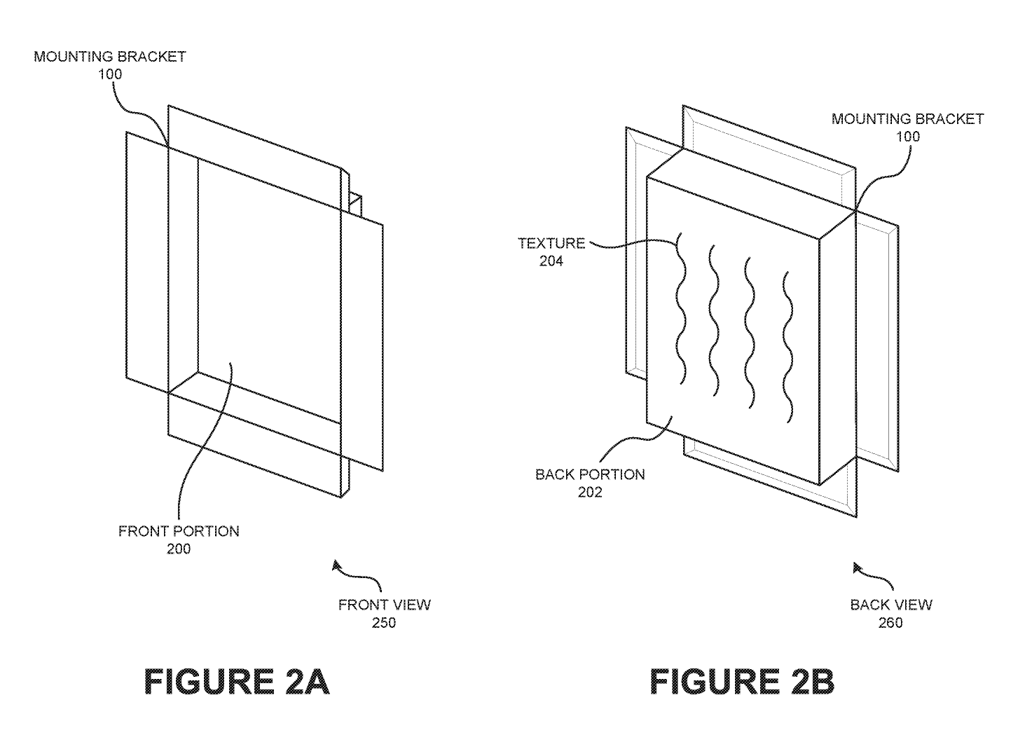

FIG. 2A is a front view 250 of a mounting bracket 100 of FIG. 1, according to one embodiment. Particularly, a front view 250 includes a front portion 200. The front portion 200 may be the forward facing portion of the mounting bracket 100 of FIG. 1.

FIG. 2B is back view 260 of the mounting bracket 100 of FIG. 1, according to one embodiment. Particularly, a back view 260 includes a back portion 202 and a texture 204. The back portion 202 may be a backward facing portion of the mounting bracket 100 of FIG. 1. The back portion 202 may be capable of being attached to an item 300 to be mounted onto the surface 302. The texture 204 may be a characteristic appearance of a back portion 202. In another embodiment, the texture 204 of the back portion 202 may be uneven to enable a higher adhesion point for attaching the back portion 202 to the item 300, according to one embodiment.

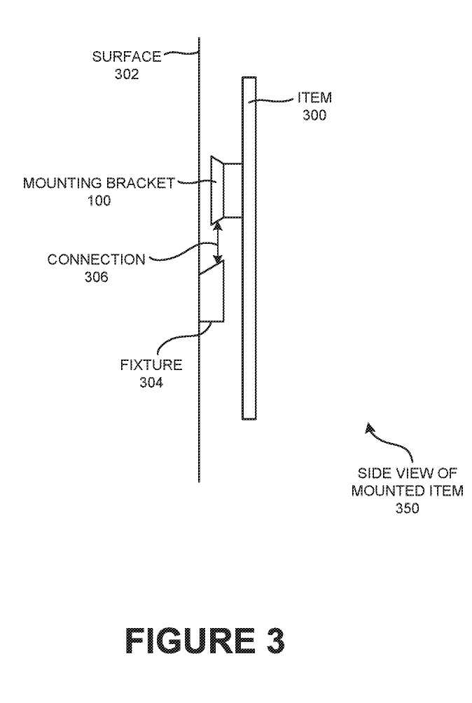

FIG. 3 is a side view of mounted item 350, according to one embodiment. Particularly, side view of mounted item 350 includes an item 300, a surface 302, a fixture 304, and a connection 306, according to one embodiment. The item 300 to be mounted may be a glass writing surface. The surface 302 may a flat vertical surface. The fixture 304 affixed to the surface 302 may be an object fixed to secure and/or support a work-piece (e.g., item 300). In another embodiment, the fixture 304 may be a securing means to hang the item 300. The fixture 304 may be a Z clip and/or a French cleat. The connection 306 may be the attachment, joint, fastening, and/or coupling of the fixture 304 and mounting bracket 100 of FIG. 1, according to one embodiment.

FIG. 4A is a specific orientations front views 450, according to one embodiment. Particularly, Circle ‘1’ to Circle ‘4’ shows the specific orientations of the item 300 in all the four directions with respect to the surface 302, according to one embodiment.

FIG. 4B is a specific orientations back views 460, according to one embodiment. Particularly, Circle ‘5’ to Circle ‘8’ shows the specific orientations of the mounting bracket 100 of FIG. 1 and the item 300 in all the four directions with respect to the surface 302. Circle ‘5’ shows the specific lip ‘A’ in connection 306 with the fixture 304. In circle ‘6’, the lip ‘A’ is rotated (clockwise direction) to 90 degrees, whereas the lip adjacent to lip ‘A’ is still in contact (using connection 306) with the fixture 304 of FIG. 3. Circle ‘7’ shows the rotation of the lip ‘A’ to 180 degrees from the original position as shown in the circle ‘5’ maintaining the contact of the adjoining lip of the mounting bracket 100 of FIG. 1 with the fixture 304 of FIG. 3. Circle ‘8’ shows the rotation of the lip ‘A’ to 270 degrees from the original position of the lip ‘A’ in circle ‘5’, according to one embodiment.

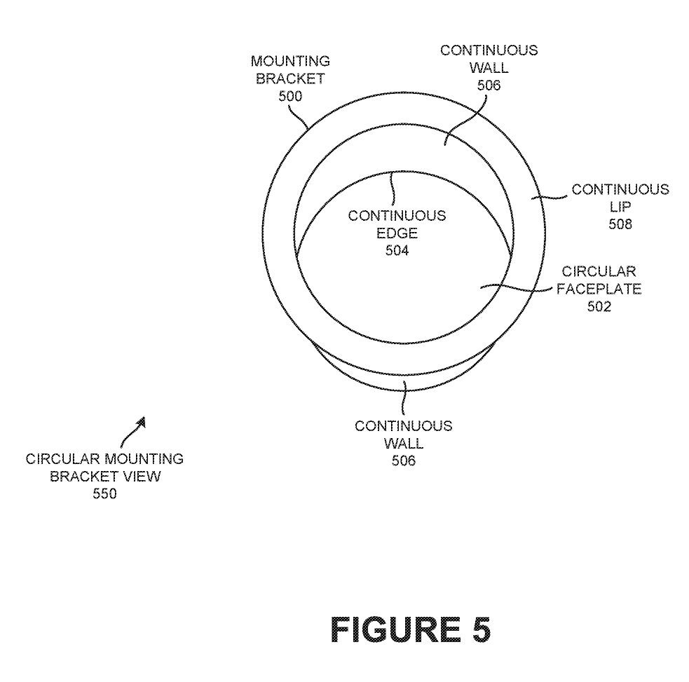

FIG. 5 is a circular mounting bracket view 550, according to one embodiment. Particularly, the circular mounting bracket view 550 includes a mounting bracket 500, a circular faceplate 502, a continuous edge 504, a continuous wall 506, and a continuous lip 508, according to one embodiment. The mounting bracket 500 may be a circular rigid structure to support an item 300. The circular faceplate 502 may be a round shaped surface. The continuous edge 504 may be along the perimeter of the circular faceplate 502. The continuous wall 506 may be a structure that encloses the circular faceplate 502. The continuous lip 508 may be a part adjoining perpendicular to the continuous wall 506, according to one embodiment.

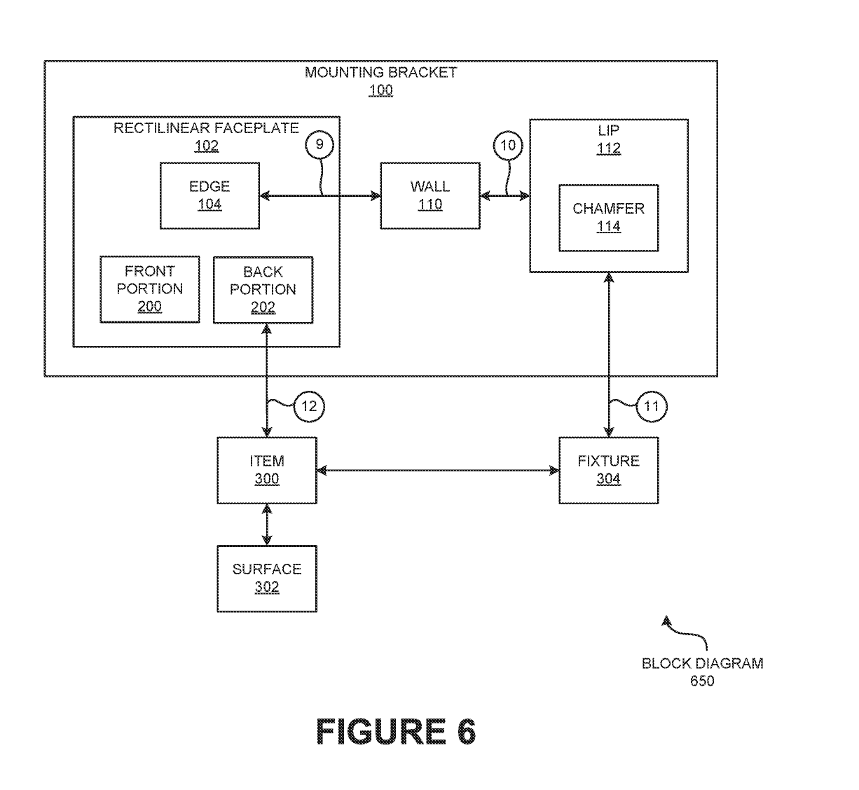

FIG. 6 is a block diagram 650 illustrating attachment of a rectilinear faceplate 102, wall(s) 110, and lip(s) 112 to an item 300, according to one embodiment. The mounting bracket 100 includes rectilinear faceplate 102. The rectilinear faceplate 102 has an edge 104, according to one embodiment. The mounting bracket 100 includes wall 110. In addition, the mounting bracket 100 includes lip 112. The lip 112 may have a chamfer 114. In circle ‘9’, the edge 104 is adjoined perpendicular to the wall 110. In circle ‘10’, the lip 112 is adjoined perpendicular to the wall 110, according to one embodiment.

The edge 104 is associated with the lip 112. In circle ‘11’, the lip 112 is attached to the fixture 304 affixed to the surface 302. In another embodiment, the rectilinear faceplate 102 may include front portion 200 and/or back portion 202. In circle ‘12’, the back portion 202 may be attached to the item 300 to be mounted on the surface 302, according to one embodiment.

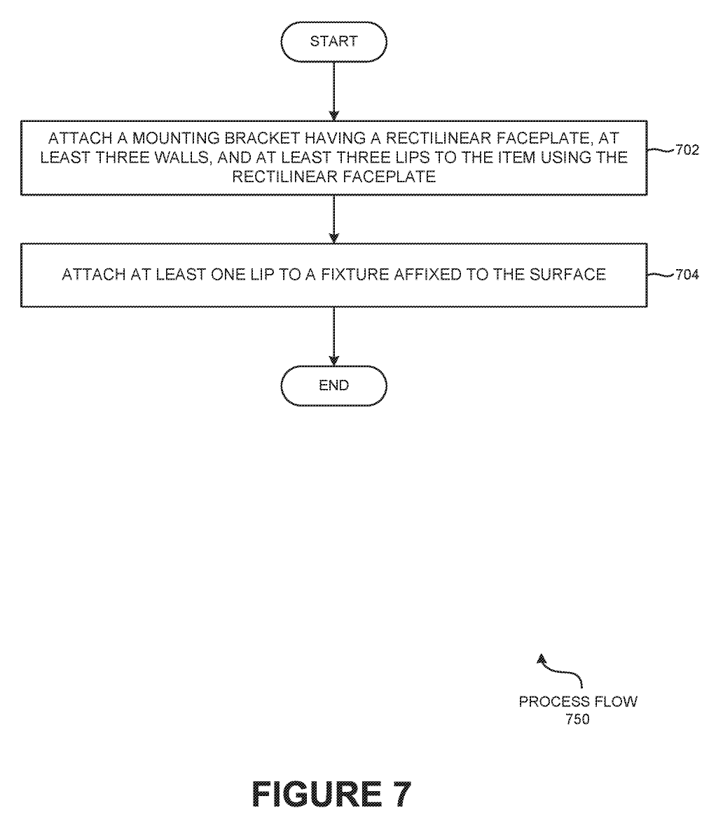

FIG. 7 is a process flow 750 of attaching a lip 112 to a fixture 304, according to one embodiment. In operation 702, the mounting bracket 100 having a rectilinear faceplate 102, three walls (e.g., wall 110), and three lips (e.g., lip 112) are attached to the item 300 using the rectilinear faceplate 102, according to one embodiment. In operation 704, the lip 112 is attached to the fixture 304 affixed to the surface 302, according to one embodiment.

An example embodiment may now be described. Sofia may be the owner of a new business, So Soft. Sofia may want her employees to use glassboards for writing down their ideas throughout the day, so she may have ordered two dozen glassboards in the spring to mount throughout the office from Gary Glassboards. In the order, Sofia may have specified that she wanted her business name, So Soft, to appear in a bottom right hand corner of each glassboard in a vertical orientation. However, when the glassboards arrive, Sofia may find that the mounting brackets are placed on half of the glassboards in such a way that these glassboard may only be mounted horizontally. Therefore, the business name So Soft appears sideways on these glassboards once they are mounted to her walls. Sofia may further find that she accidentally specified in her order that the mounting brackets for the remaining glassboards be installed so that the remaining glassboards may be mounted vertically, but in such a way that the business name So Soft appears in the top left hand corner, upside down. Sofia may find that the mounting brackets only have a single lip and therefore she cannot simply rotate the glassboards so that they are in the proper orientation.

Sofia may contact Gary to have the problem fixed. Gary may inform Sofia that the only option is to send Terry, a technician, who will uninstall the mounting brackets and place them in the proper orientation. Gary may inform Sofia that she will have to pay additional service fees to have Terry fix the mounting brackets on the glassboards where she specified the placement of the mounting brackets, however, Gary would not charge Sofia for Terry to fix the mounting brackets that Gary had improperly installed. Terry may come to the offices of So Soft and begin uninstalling the mounting brackets and placing them in the proper orientation. However, Terry may find that he is unable to remove some mounting brackets and informs Sofia that he will have to come back later and simply install additional brackets so that the glassboards may be mounted in the proper orientation.

Sofia may find that the mounting brackets with a single lip have caused significant delays in allowing her employees to start utilizing the glassboards and/or incurred significant unforeseen costs when she mistakenly provided the wrong specifications to Gary. Further, Gary may find that the single lip mounting brackets are prone to human error in the installation process and/or often lead to significant additional costs if he needs to use a technician to fix installed mounting brackets that were improperly placed.

Thankfully, Gary may learn about the new multidirectional mounting bracket (as described in FIGS. 1-7) from an industry colleague. Gary may decide to invest money and switch to using the multidirectional mounting bracket for future glassboard installations. Gary may find that this significantly decreases the amount of human error in the mounting bracket installation process and/or saves him a significant amount of money in sending technicians to remedy faulty installations. Gary may also find that the new multidirectional mounting brackets eliminate the possibility that customers will provide the wrong specifications. Further, Gary learns from customers using the new multidirectional mounting brackets allow them to change the orientation of the glassboards if the customers later find that they want the glassboards in a new orientation.

Gary may be so excited about the benefits that the new multidirectional mounting brackets provide to his customers that that he notifies all his previous customers who had purchased glassboards with the single lip mounting bracket to inform them of this new multidirectional mounting bracket and its benefits.

The following fall, Sofia's business may have experienced a large growth and she may want to order more glassboards. Sofia may recall receiving the email from Gary explaining that he is using a new multidirectional mounting bracket. Sofia may decide to order an additional two dozen glassboards from Gary. When Sofia places her new order, she may not need to specify which orientation she plans to install the glassboards. Further, Sofia may decide to have the So Soft logo placed on the glassboards, which can be viewed properly in any orientation. Sofia may decide to do this knowing that the new mounting brackets will permit her to easily reorient the glassboards at a future time if she desires. When Sofia first placed this new order, she may have anticipated mounting each glassboard vertically. However, while waiting for the new order, she may decide that she would like to mount some glassboards horizontally. Upon receiving the new order that uses the new multidirectional mounting brackets, she may find that she is easily able to orient each glassboard in a horizontal and/or vertical orientation without the need to have a technician reinstall the mounting brackets. Sofia's employees may even notice how easy it is to reorient the glassboards using the new mounting brackets and may quickly change the glassboard orientation if it better suits their needs at a given time. Sofia may now recommend the glassboards that use the multidirectional mounting brackets to her colleagues and friends.

A number of embodiments have been described. Nevertheless, it will be understood that various modifications may be made without departing from the spirit and scope of the claimed invention. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A mounting bracket comprising:
a rectilinear faceplate, having a front surface and a back surface,
wherein the rectilinear faceplate has at least three edges,
wherein adjacent edges produce a specific angle between the adjacent edges, and
wherein the back surface of the rectilinear faceplate is fixedly attached to an item to be mounted onto a surface of a supporting structure;
at least three walls,
wherein each edge is adjoined perpendicular to at least one corresponding wall; and
at least three lips, each of the at least three lips having chamfered edges and configured to removably engage with a fixture secured to the surface of the supporting structure, the at least three lips being separable from each other to form a space therebetween, the at least three lips configured to slidingly engage with the fixture,
wherein each lip is adjoined perpendicular to the at least one corresponding wall such that each edge is associated with at least one corresponding lip,
wherein each lip is capable of attaching to the fixture affixed to the surface of the supporting structure, wherein the mounting bracket allows the item to be mounted on the surface in at least two specific orientations, and
wherein the at least two specific orientations are determined based on being able to rotate the item by a difference between 180 degrees and the specific angle.

2. The mounting bracket of claim 1, wherein the fixture is at least one of a Z clip and a French cleat.

3. The mounting bracket of claim 1:
wherein the rectilinear faceplate is at least one of a square and a rectangle,
wherein the specific angle is 90 degrees,
wherein the mounting bracket allows the item to be mounted on the surface in four specific orientations, and
wherein the four specific orientations are determined based on being able to rotate the item by 90 degrees, 180 degrees, 270 degrees, and 360 degrees.

4. The mounting bracket of claim 1:
wherein the chamfer is configured to enable each lip to self-actuate a connection to the fixture and tighten the connection as each lip is attached to the fixture.

5. The mounting bracket of claim 1:
wherein the rectilinear faceplate comprises a front portion and a back portion,
wherein the back portion is capable of being attached to an item to be mounted onto the surface, and
wherein the back portion comprises an uneven texture to enable a higher adhesion point for attaching the back portion to the item.

6. The mounting bracket of claim 1, wherein the mounting bracket is comprised of a metal alloy.

7. The mounting bracket of claim 1, wherein the item to be mounted is a glass writing surface.

8-20. (canceled)
